(19) United States
(12) Patent Application Publication
(10) Pub. No.: US 2026/0203687 A1
(43) Pub. Date: Jul. 16, 2026

(54) ABILITY TO DETERMINE IN REAL TIME AVAILABILITY OF RESOURCES TO PERFORM ENGINEERING WORK IN A NON-PRODUCTION ENVIRONMENT

(71) Applicant: Bank of America Corporation, Charlotte, NC (US)

(72) Inventor: Arthur Guberman, Freehold, NJ (US)

(21) Appl. No.: 19/017,675

(22) Filed: Jan. 12, 2025

(51) Int. Cl. G06Q 10/0631; G06F 9/54

(52) U.S. Cl. CPC G06Q 10/063118; G06F 9/54

(57) ABSTRACT

Systems for addressing a non-production task in a non-production level environment in a computer network of an organization may be provided that integrate a production level environment in the computer network with the non-production level environment. A processor may have electronic communication with a receiver and transmitter. The processor may receive a non-production task, triage to see if an electronic bridge is currently handling the task, if not, create an electronic bridge to handle the task, and send an API request to determine which responders in the organization are equipped to handle the request and are currently available, i.e., not on another electronic bridge. Upon receiving a response from the API, the processor may identify one or more responders and send them an electronic prompt to join the electronic bridge. One or more responders may join the electronic bridge that addresses the non-production task.

### FIELD OF TECHNOLOGY

Aspects of this disclosure relate to addressing non-production tasks in a non-production level environment of a computer network. Specifically, the disclosure relates to integration of the production and non-production level environments of the computer network to assemble on-call responders to address a task in the non-production level environment.

### BACKGROUND

Engineering teams may split their time between performing tasks in a non-production environment and in a production environment. Organizations may have need engineers to join a team addressing an issue in the non-production environment or in the production environment. The team may address the issues using an electronic bridge, i.e., a formal electronic construct for use in response to the issue.

The process of organizing an electronic bridge that contains all the necessary team members may be cumbersome. For example, the people who are needed may be located remotely from each other. An electronic call or page may go out to the desired team members to join. It may take some time to determine whether a potential member is not responding, and an alternative member should be selected.

A system has been developed for the production environment that provides insight into the status of potential team members for joining an electronic bridge to address a service outage incident in a computer network. The product may be called virtual on-watch as described in U.S. Pat. No. 11,902,117, filed on Nov. 18, 2022, and entitled, “Virtual On-Watch”, which is hereby incorporated by reference herein in its entirety.

However, there are challenges to implement a system like virtual on-watch in the non-production environment. First, virtual on-watch is implemented to organize electronic bridges to solve service outage incidents in the production environment. Service outage incidents may be an urgent matter. There may not be service outage incidents in the non-production environment. Furthermore, the types of activities Second, virtual on-watch depends on maintaining a list of on-call staff, such as engineers, that can potentially assist with service outage incidents. There may not be a concept of on-call engineers for participation in the non-production environment. Third, virtual on-watch may require all bridges handling service outage incidents to use the same bridge platform, for example, a commercially available bridge platform in order to track the availability of the on-call engineers. There may not be a requirement for on-call engineers to use the same bridge platform. Fourth, virtual on-watch has visibility into bridges taking place in the production environment. Virtual on-watch may not have visibility into the non-production environment to know what bridges are taking place in the non-production environment. Fifth, virtual on-watch may only have visibility in the production environment. Virtual on-watch may not have visibility into the non-production environment. Virtual on-watch may not have visibility across multiple environments, such as the production environment and non-production environment. Sixth, virtual on-watch addresses service outage incidents that by their nature are contained episodes. The electronic bridge formed to address service outage incidents may be kept active until the episode is completed and the issue is resolved. Due to the contained nature of the bridge, each member of the bridge is likely to remain on the bridge until the episode is resolved. However, engineering issues that arise in the non-production environment may be part of an on-going efforts to implement a new feature or develop new functions that may span multiple bridges. Additionally, engineering members who are on-call and join the bridge may drop off the bridge before the bridge is completed. Alternatively, they may only participate in one bridge while the non-production task may span multiple bridges.

It would be desirable to have a VOW system that addresses some or all the deficiencies described above.

### SUMMARY

Provided may be a non-production VOW that addresses some or all of the deficiencies mentioned previously.

This disclosure may situate virtual on-watch (“VOW”) in the non-production environment. This non-production VOW may address any tasks that arise in the non-production environment. Examples of tasks include task that addresses a change request (“CRQ”), manages a database, implements a security feature, reviews code, designs software architecture, writes code, tests applications, debugs an engineering issue, optimizes performance of a component located in the production level environment or non-production level environment, documents technical specifications, collaborates with teams in the production level environment, or maintains existing software systems to address updates or fix bugs.

The issues together may be referred to as non-production tasks. The non-production tasks may arise in the non-production level environment. The non-production tasks may include non-urgent tasks. Non-production tasks may include only non-urgent issues. Non-production tasks may exclude service outage incidents.

The non-production VOW may establish a system whereby an on-call system is established for engineers working in the non-production environment. The on-call system may include a list of the engineers who can be contacted to join an electronic bridge when an issue arises in the non-production environment.

The non-production VOW may coordinate with all the responders in the non-production environment to use one or more specific electronic bridge platforms that the non-production VOW tracks. The organization may require that any responder who is on-call uses a bridge on an electronic bridge platform that is monitored by the non-production VOW. The electronic bridge platforms may include commercially available bridge platforms, a proprietary bridge platform that is not commercially available, and/or a bridge platform that is available as an open-source software package.

The non-production VOW may have visibility into bridges that are in-progress in the non-production environment. This may provide the non-production VOW with information about which engineers that are on-call are available to join a new electronic bridge. Furthermore, the non-production VOW may allow for integration of multiple bridge platforms.

The non-production VOW may span more than one bridge. The non-production VOW may bring on a responder for just one bridge, or part of one bridge. The participation in the bridges by the different responders may overlap, may be identical, or may include participation that does not overlap.

The non-production VOW may follow a set of rules regarding seeking responders to participate on a non-production bridge. The set of rules may include determining if the responder is on-call, determining if the responder is on a production bridge, and determining if the responder is on a non-production bridge. If a responder is still available after running through the set of rules, the responder may be invited to the non-production bridge.

After the responder accepts and/or is already participating in the non-production bridge, if there is a need for the responder's assistance on a production bridge, the responder may be sent an invitation to join the production bridge. If the responder accepts the new invitation, the responder may leave the non-production bridge. However, if after the responder accepts and/or is already participating in the non-production bridge, there is a need for the responder's assistance on a non-production bridge, the non-production VOW may allow this responder to stay on the current bridge and rather seek a different responder to join the other non-production bridge. In one scenario, if there is no other responder available, the non-production VOW may determine which of the two non-production matters is more critical to the organization. If the new matter is more critical to the organization, the non-production VOW may send a request to the responder to join the new bridge. If the current matter is more critical to the organization, the non-production VOW may take no action, allowing the responder to stay on the current bridge.

It is an object of this disclosure to provide automated systems and methods for managing resources in the non-production environment. It would be desirable to provide systems and methods that provide management tools for handling tasks in the non-production environment.

Provided are systems and methods for addressing a non-production task in a non-production level environment in the computer network by integrating a production level environment in the computer network with the non-production level environment. This integration may assist in addressing a non-production task. The non-production task may include a task that addresses a change request (“CRQ”), manages a database, implements a security feature, reviews code, designs software architecture, writes code, tests applications, debugs an engineering issue, optimizes performance of a component located in the production level environment or non-production level environment, documents technical specifications, collaborates with teams in the production level environment, or maintains existing software systems to address updates or fix bugs. The non-production task may be performed and/or integrated in the non-production level environment.

Provided are one or more non-transitory computer-readable media storing computer-executable instructions which, when executed by a processor, may perform a method addressing a non-production task in a non-production level environment in the computer network by integrating a production level environment in the computer network with the non-production level environment. The processor may be located within a computer. The computer may be located within a computer network. The processor may include a central processing unit (“CPU”).

The method may include using a receiver that is in electronic communication with the processor to receive a request to perform the non-production task in the non-production level environment. The non-production task may be implemented within the non-production level environment of the computer network. The non-production level environment may include a lower level environment and an upper level environment.

The processor in electronic communication with an electronic bridge platform may determine whether there is a previous-in-time electronic bridge that is still operational that addresses the non-production task. When there is no previous-in-time electronic bridge that is still operational that addresses the non-production task, the processor in electronic communication with the electronic bridge platform may automatically arrange a first electronic bridge to serve as an electronic staging area to address the non-production task in the non-production level environment. The first electronic bridge may be provided by the electronic bridge platform.

The processor may determine all responders in an organization that are qualified to address the non-production task in the non-production level environment. The processor may determine all responders in the organization that are on-call to address matters arising in the non-production level environment.

A transmitter in electronic communication with the processor may transmit an Application Programming Interface (“API”) request to an electronic bridge platform to determine all electronic bridges taking place in the production level environment and/or all electronic bridges taking place in the non-production level environment. The transmitter in electronic communication with the processor may transmit an API request to an electronic bridge platform to determine electronic bridges taking place in the production level environment and/or electronic bridges taking place in the non-production level environment.

The transmitter in electronic communication with the processor may transmit an API request to an electronic bridge platform to determine all responders who are on electronic bridges taking place in the production level environment and/or all electronic bridges taking place in the non-production level environment. The transmitter in electronic communication with the processor may transmit an API request to an electronic bridge platform to determine responders who are on electronic bridges taking place in the production level environment and/or all electronic bridges taking place in the non-production level environment.

The electronic bridge platform may be in electronic communication with a non-production virtual on-watch in the non-production level environment and/or a production virtual on-watch in the production level environment. The non-production virtual on-watch may include a comprehensive review of resources available in the non-production level environment. The production virtual on-watch may include a comprehensive review of resources available in the production level environment. Resources may include responders. The responders may be on-call. The responders may join an electronic bridge to address the non-production task.

The transmitter in electronic communication with the processor may receive an API response with data from the electronic bridge platform relating to electronic bridges, such as all electronic bridges, taking place in the production level environment and/or in the non-production level environment. The transmitter may receive an API response with data from the electronic bridge platform relating to responders, such as all responders, who are on electronic bridges taking place in the production level environment and/or in the non-production level environment. The API response may include electronic bridge platform information from the non-production virtual on-watch and the production virtual on-watch.

The processor and the API response may determine, by integrating feedback from the production virtual on-watch with the non-production virtual on-watch, a set of responders that are qualified to address the non-production task, are on-call to address matters arising in the non-production level environment, are not on an electronic bridge in the production level environment, and/or are not on an electronic bridge in the non-production level environment.

The processor in electronic communication with the electronic bridge platform may send to one or more responders from the set of responders an electronic prompt to join the first electronic bridge. The one or more responders may be identified as qualified to address the non-production task, on-call to address matters arising in the non-production level environment, and/or not currently on an electronic bridge in the production level environment or in the non-production level environment. The processor in electronic communication with the electronic bridge platform may receive an acceptance of the electronic prompt to join the first electronic bridge from the one or more of the set of responders.

The method may may further include where the non-production task addresses a change request (“CRQ”), manages a database, implements a security feature, reviews code, designs software architecture, writes code, tests applications, debugs an engineering issue, optimizes performance of a component located in the production level environment or non-production level environment, documents technical specifications, collaborates with teams in the production level environment, or maintains existing software systems to address updates or fix bugs.

The non-production task may include a task that is not a service outage incident. The non-production task may be addressed at the non-production level environment. The non-production task may be addressed in an environment that is not a production level environment. The non-production level environment of the computer network may include a lower level environment and an upper level environment.

The computer network may include a computer network of the organization. The set of responders may be associated with the organization. The responders within the set of responders may control computing devices that are within the computer network. The responders within the set of responders may control computing devices that are outside of the computer network. The production virtual on-watch and the non-production virtual on-watch may include different virtual on-watches. The production virtual on-watch may include the non-production virtual on-watch.

The one or more responders may join the first electronic bridge. The one or more responders may leave the first electronic bridge when the first electronic bridge is terminated. The one or more responders may leave the first electronic bridge when participation of the one or more responders in the first electronic bridge is completed.

After one or more responders join the first electronic bridge, at least one responder of the one or more responders may leave the first electronic bridge to join another electronic bridge that is addressing a service outage incident in the production level environment. The method may further include sending, using the processor in electronic communication with the electronic bridge platform, an electronic prompt to join the first electronic bridge to one or more responders of a second set of responders, where the one or more responders of the second set or responders are identified as being qualified to address the non-production task, as being on-call to address matters arising in the non-production level environment, and are not currently on an electronic bridge in the production level environment or in the non-production level environment. The processor in electronic communication with the electronic bridge platform may receive an acceptance of the electronic prompt to join the first electronic bridge from the one or more responders of the second set of responders

### BRIEF DESCRIPTION OF THE DRAWINGS

The objects and advantages of the invention will be apparent upon consideration of the following detailed description, taken in conjunction with the accompanying drawings, in which like reference characters refer to like parts throughout, and in which:

FIG. 1 shows an illustrative block diagram of a system configured to address a non-production task in a non-production level environment in a computer network of an organization by integrating a production level environment in the computer network with the non-production level environment in accordance with the principles of the disclosure;

FIG. 2A shows an illustrative flowchart of a method for addressing a non-production task in a non-production level environment in the computer network by integrating a production level environment in the computer network with the non-production level environment;

FIG. 2B shows an illustrative flowchart of a method for addressing a non-production task in a non-production level environment in the computer network by integrating a production level environment in the computer network with the non-production level environment;

FIG. 3 shows an illustrative table showing the availability of on-call responders;

FIG. 4 shows an illustrative block diagram of a system configured to show an integration of a production level environment with a non-production level environment to identify an on-call responder who can join bridge in the non-production level environment;

FIG. 5 shows an illustrative block diagram in accordance with principles of the disclosure; and

FIG. 6 shows an illustrative block diagram in accordance with principles of the disclosure.

### DETAILED DESCRIPTION

The stages of software development may be divided into various environments. These environments may include lower environments, upper environments, and a production environment. Together, the lower environments and the upper environments may be referred to as non-production environments. Software development may include the development of a software product, software package, software application, and/or software system.

A software product may include a complete software application that solves a specific user problem. The software product may include a single program or a collection of programs within a software package. A software package may include a group of related programs bundled together for distribution.

A software application may include a specific program designed to perform a particular task for the user. The software application may run on top of a software system. The software system may encompass an entire software infrastructure including the operating system and other foundational components.

The lower environments in software development may include more controlled spaces than the upper environments and the production environment. Lower environments may include, for example, a development environment and a testing environment. The development environment may include a workspace where developers write and modify code. It may also include a place to conduct integration tests. Integration testing may include testing that verifies the interactions between components of a software application.

The lower environments may serve as an important stage in a software development lifecycle. The lower environments may help to reduce the risks associated with deploying software in the production level environment. For example, the lower environments may be dedicated to the early stages of software development. It may be where software developers write and modify code, conduct unit testing, and verify basic functionalities.

The lower environments may be used to develop, validate, and/or test software. The lower environments may be used to refine software code before releasing it to the upper environment and/or the production environment. In this disclosure, the lower environments may be referred to collectively as the lower level environment.

The upper environments may include the final stages of the development and testing process. The upper environments may include, for example, a staging environment and a user acceptance testing (UAT) environment. The staging environment may include where a final build of the software is deployed to simulate real-world conditions and/or where performance testing is performed before going to a production environment. The UAT environment may include a dedicated environment where end users and/or representatives test the software to validate its functionality against real-world requirements.

The software may be thoroughly tested in the upper environments before being deployed to the live production environment. The upper environments may ensure that the software meets quality standards and is ready for real-world use by end users. The upper environments may include the last steps before release to the public. In this disclosure, the upper environments may be referred to collectively as the upper level environment.

Together, the lower level environment and the upper level environment may be referred to collectively the non-production environment.

The lower level environment and the upper level environment may be less secure than the production environment. Security controls may be added to these levels to improve security and monitoring. For example, security measures such as encrypting data, regulating user permissions, and/or adhering to data retention policies may increase security.

The production environment may refer to a final stage of the software's development. It may include where a fully tested and/or approved application is deployed and accessible to end users. At this stage, the version of the software may be considered the live version of the software. Users may interact with the software in a real-world setting. The production environment may come after the non-production environment, such as after the lower level environment /d/ the upper level environment. Changes in the production environment may need to be carefully managed to ensure minimal disruption to users. The production environment may be referred to as the production level environment.

Outages in the software, such as software product, software package, and/or software system, may need to be corrected in an urgent manner. Some key issues that may arise due to an outage in the software during production include the following: customer impact, financial consequences, operational disruption, and technical issues. Customer impact may include disruption of services received using the software, negative perception of the brand using the software, and/or inability to access software products, software package, and/or software system.

Financial consequences may include potential costs related to recovery efforts and/or lost revenue and/or sales due to the unavailability of the software. Operational disruption may include challenges in data processing and/or retrieval, disruption of internal workflow and/or business processes, and/or difficulty in managing customer support inquiries. Technical issues may include potential loss of data or data corruption due to the unexpected system shutdown, challenges in implementing emergency measures, and/or struggles in identifying the root cause of problem.

The non-production task may include addressing a CRQ, managing databases, implementing security features, reviewing code from peers, designing software architecture, writing code, testing applications, debugging issues, optimizing performance, documenting technical specifications, collaborating with teams in the production level environment, and/or maintaining existing software systems to address updates and bug fixes. The non-production task may arise during the software development lifecycle. The non-production task may include a request to alter the software such as a software package or a software application. The non-production task may include a request to alter software that operates with a product and/or a system.

The non-production task may originate from various sources including but not limited to stakeholders, project sponsors, new business requirements, technical issues, market trends, regulatory changes, internal team members, bug reports, customer feedback, competitor analysis, and/or internal system updates. The non-production task may be prompted by essentially any source that desires for a modification to be made in the existing software design or functionality.

The non-production task may typically be processed at the non-production level before being implemented in the production environment. The reason they may be processed at the non-production level may include that although they may be important, their implementation may not affect current production functionality. Hence, non-production tasks may best be handled in the non-production environment. The non-production task may be tested and validated in a non-production environment before being deployed in the production environment to live systems where users interact with them. The non-production task may be processed in the lower level environment first, and then in the upper level environment, or directly in the upper level environment, before eventually being deployed in the production environment.

The level at which the non-production task is initially processed may relate to the complexity and/or impact of the change being requested. Levels of non-production task may include minor change requested, moderate change requested, or major change requested. A minor request may be implemented in the upper level environment, for example, by individual developers with minimal impact on the overall system. A moderate request may be implemented in either the lower level environment or the upper level environment. Moderate requests may require more significant code modifications than minor requests and may affect multiple components. Major requests may be implemented in the lower level environment first and then in the upper level environment. Major requests may require large-scale changes that significantly alter the software's functionality, potentially requiring cross-team collaboration and extensive design updates.

Provided are systems and methods for providing integration of a production level environment in a computer network with a non-production level environment of the computer network. This integration may assist in addressing a request for a non-production task. The non-production task may be performed and/or integrated in the non-production level environment.

A benefit of the provided systems and methods of this disclosure may include knowledge of availability in real-time of responders who are equipped to address the non-production task. Another benefit may include linking knowledge of responder availability in the production environment with responder availability in the non-production environment. Linking the knowledge of these different environments may provide a more comprehensive picture of responder availability. Combining these benefits may inform the systems and methods about which responders to send electronic prompts to join an electronic bridge to address the non-production task.

Provided are systems for addressing a non-production task in a non-production level environment in a computer network of an organization by integrating a production level environment in the computer network with the non-production level environment.

The system may include a processor located in the computer network of the organization. The processor may be in a computer. The computer may be in the computer network. The processor may include a CPU.

The system may include a receiver in the computer network. The receiver may be in electronic communication with the processor. The system may include a transmitter in the computer network. The transmitter may be in electronic communication with the processor. The system may include a non-production level environment in the computer network. The system may include a non-production virtual on-watch in the non-production level environment. The non-production virtual on-watch may include a comprehensive review of resources available in the non-production level environment. The system may include a production level environment in the computer network. The production virtual on-watch may be in the production level environment. The production virtual on-watch may include a comprehensive review of resources available in the production level environment. The system may include a first electronic bridge.

The receiver may be configured to receive a request to perform the non-production task in the non-production level environment.

The processor may be in electronic communication with an electronic bridge platform and configured to determine whether there is a previous-in-time electronic bridge that is still operational that addresses the non-production task. When there is no previous-in-time electronic bridge that is still operational that addresses the non-production task, the processor that is in electronic communication with an electronic bridge platform may be configured to automatically arrange the first electronic bridge to serve as an electronic staging area to address the non-production task in the non-production level environment. The first electronic bridge may be provided by the electronic bridge platform.

An example of an electronic bridge platform that is available commercially includes a conference bridge platform. Examples of conference bridge platforms include Webex®, Microsoft Teams®, Zoom®, Dialpad®, Skype®, and Google Meet®. Other video conference platforms may be included. In one example, exemplary conference bridge platforms may include Webex and Microsoft Teams. In another example, exemplary conference bridges may exclude Webex. In a further example, Webex and Microsoft Teams are integrated to share information about existing electronic bridges. Integrating various electronic bridge platforms, such as Webex and Microsoft Teams, may include electronically stitching together the different platforms.

The transmitter is configured to transmit an API request to an electronic bridge platform. The API request may determine electronic bridges, such as all electronic bridges, taking place in the production level environment, and/or electronic bridges, such as all electronic bridges, taking place in the non-production level environment. The API request may determine responders, such as all responders, who are on electronic bridges taking place in the production level environment, and/or responders, such as all responders, who are on electronic bridges taking place in the non-production level environment. The electronic bridge platform may have electronic communication with the non-production virtual on-watch and/or the production virtual on-watch.

The transmitter may be configured to receive an API response with data from the electronic bridge platform relating to the electronic bridges, such as data relating to all the electronic bridges, taking place in the production level environment and in the non-production level environment. The transmitter may be configured to receive an API response with data from the electronic bridge platform regarding responders, such as data relating to all responders, who are on electronic bridges taking place in the production level environment and the non-production level environment. The API response may include electronic bridge platform information from the non-production virtual on-watch and/or the production virtual on-watch.

The processor may be configured to determine all responders, or at least one responder, in the organization that is qualified to address the non-production task in the non-production level environment. The processor may be configured to determine all responders, or at least one responder, in the organization that is on-call to address matters arising in the non-production level environment.

The processor may be configured to determine, by integrating feedback from the production virtual on-watch with the non-production virtual on-watch, and/or with use of the API response, a set of responders. The set of responders may be qualified to address the non-production task, are on-call to address matters arising in the non-production level environment, are not on an electronic bridge in the production level environment, and/or are not on an electronic bridge in the non-production level environment.

The processor in electronic communication with an electronic bridge platform may be configured to send to one or more responders from the set of responders an electronic prompt to join the first electronic bridge. The one or more responders may be identified as being qualified to address the non-production task, as being on-call to address matters arising in the non-production level environment, and/or are not currently on an electronic bridge in the production level environment or in the non-production level environment. The processor in electronic communication with an electronic bridge platform may be configured to receive an acceptance of the electronic prompt to join the first electronic bridge from the one or more of the set of responders.

The system may may further include where the non-production task addresses a change request (“CRQ”), manages a database, implements a security feature, reviews code, designs software architecture, writes code, tests applications, debugs an engineering issue, optimizes performance of a component located in the production level environment or non-production level environment, documents technical specifications, collaborates with teams in the production level environment, or maintains existing software systems to address updates or fix bugs.

The non-production task may include a task that is not a service outage incident. The non-production task may be addressed at the non-production level environment. The non-production task may be addressed in an environment that is not a production level environment. The non-production level environment of the computer network may include a lower level environment and an upper level environment.

The computer network may include a computer network of the organization. The set of responders may be associated with the organization. The responders within the set of responders may control computing devices that are within the computer network. The responders within the set of responders may control computing devices that are outside of the computer network. The production virtual on-watch and the non-production virtual on-watch may include different virtual on-watches. The production virtual on-watch may include the non-production virtual on-watch.

The one or more responders may join the first electronic bridge. The one or more responders may leave the first electronic bridge when the first electronic bridge is terminated. The one or more responders may leave the first electronic bridge when participation of the one or more responders in the first electronic bridge is completed.

After one or more responders join the first electronic bridge, at least one responder of the one or more responders may leave the first electronic bridge to join another electronic bridge that is addressing a service outage incident in the production level environment. The method may further include repeating earlier steps of the method in order to replace at least one responder who has left the first electronic bridge.

The processor in combination with the electronic bridge platform may be further configured to integrate the production VOW and the non-production VOW with each other. The integrated production VOW and non-production VOW may be configured to identify a set of responders that are electronically identified as qualified to respond to the non-production task, that are not listed among the plurality of responders that are currently involved in one or more of the plurality of electronic bridges, and/or that are electronically listed on the electronic bridge platform as available to join the first electronic bridge. The integrated production VOW and non-production VOW may send an electronic prompt to the set of responders to join the first electronic bridge.

The integrated production VOW and non-production VOW may help identify a set of responders who are not already participating in an existing electronic bridge. An example of an existing electronic bridge may include an electronic bridge organized to address a service outage incident. Another example of the existing electronic bridge may include an electronic bridge organized to address a different non-production task.

The electronic prompt may include sending a Short Message Service (“SMS”) message, also known as a text message, an email message, a page, and/or a phone call. The electronic prompt may include any electronic method for communication.

Two or more members of the set of responders may accept the electronic prompt to join the first electronic bridge. There may be a subsequent need for one or more members of the set of responders to join an electronic bridge that addresses a service outage incident in the production level environment. The processor may send another electronic prompt to one or more responders that are identified as qualified to respond to the non-production task, are not listed among the plurality of responders that are currently involved in at least one of the plurality of electronic bridges, and/or are electronically listed on the electronic bridge platform as available to join the first electronic bridge.

The processor may reduce the number of responders on the first electronic bridge after a predetermined period of time. The predetermined period of time may be 24 hours, one day, 72 hours, three days, five business days, one week, two weeks, or one month.

The processor may reduce the number of responders on the first electronic bridge by sending a notification to one or more responders on the bridge requesting that they leave the bridge. The processor may reduce the number of responders on the first electronic bridge by sending a notification to one or more responders on the bridge informing them that their participation in the bridge will be terminated in a predetermined amount of time. The processor may automatically terminate the participation of the one or more responders after a certain amount of time has elapsed. The time may be one hour, 6 hours, one day, three days, five days, or one week.

The processor may terminate the first electronic bridge when the processor receives notification that the non-production task has been completed and/or closed. The processor may terminate the first electronic bridge after a certain predetermined amount of time. The processor may inform the participants that the first electronic bridge will be terminated after a certain predetermined amount of time. The predetermined amount of time may be one day, three days, five days, one week, two weeks, or one month.

The system may include wherein the non-production task is not a service outage incident in the computer network. A service outage incident may be an incident that occurs at the production level. A service outage incident may be an urgent matter. The system may further include where the computer network is an organization's computer network, and the responders are associated with the organization. The system may include where the set of responders includes two or more responders. The system may further include where the production VOW and the non-production VOW are different virtual on-watchers. The system may include where the production VOW and the non-production VOW are the same virtual on-watch.

The systems and methods described herein are illustrative. Systems and methods in accordance with this disclosure will now be described in connection with the figures, which form a part hereof. The figures show illustrative features of systems and methods in accordance with the principles of this disclosure. It is to be understood that other embodiments may be utilized, and that structural, functional, and procedural modifications may be made without departing from the scope and spirit of the present disclosure.

The steps of methods may be performed in an order other than the order shown or described herein. Embodiments, such as systems and/or methods, may omit steps shown and/or described in connection with illustrative methods. Embodiments may include steps that are neither shown nor described in connection with illustrative methods.

Illustrative method steps may be combined. For example, an illustrative method may include steps shown in connection with another illustrative method.

Systems may omit features shown or described in connection with illustrative systems. Embodiments may include features that are neither shown nor described in connection with the illustrative systems. Features of illustrative systems may be combined. For example, an illustrative embodiment may include features shown in connection with another illustrative embodiment.

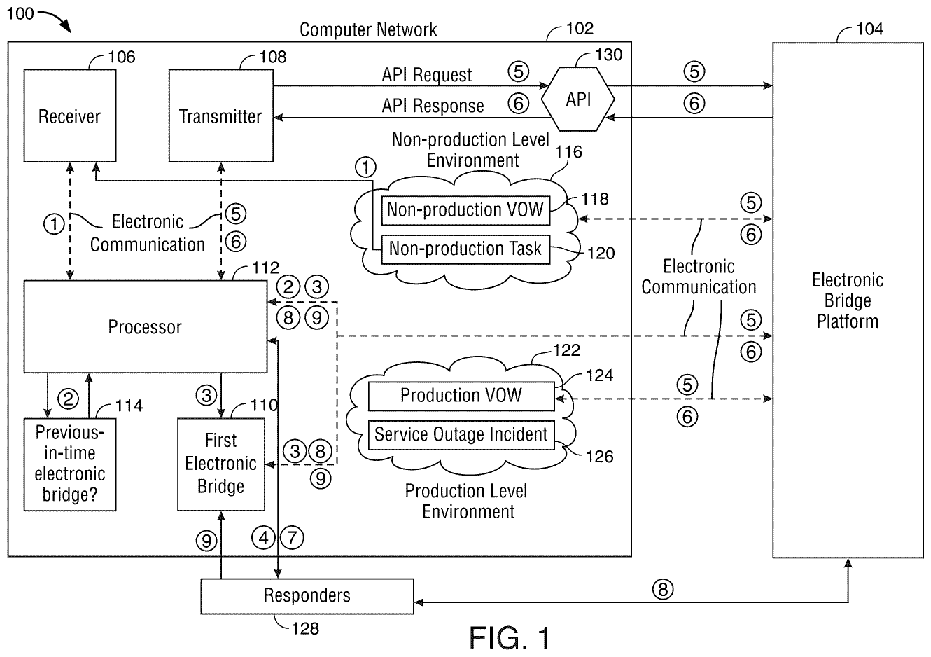

FIG. 1 shows illustrative block diagram 100. Block diagram 100 may include a system for providing integration of production level environment 122 with non-production level environment 116 in computer network 102 to address non-production task 120.

At step 1, receiver 106, which is in electronic communication with processor 112, may receive a request to perform non-production task 120 in non-production level environment 116. Non-production task 120 may be implemented within non-production level environment 116 of computer network 102. Non-production level environment 116 may include a lower level environment and an upper level environment.

Non-production task 120 may include a task that addresses a change request (“CRQ”), manages a database, implements a security feature, reviews code, designs software architecture, writes code, tests applications, debugs an engineering issue, optimizes performance of a component located in the production level environment or non-production level environment, documents technical specifications, collaborates with teams in the production level environment, or maintains existing software systems to address updates or fix bugs.

At step 2, processor 112, in electronic communication with electronic bridge platform 104, may determine whether there is previous-in-time electronic bridge 114 that is still operational that addresses the non-production task.

At step 3, when it is determined that there is no previous-in-time electronic bridge 114 that is still operational that addresses non-production task 120, arranging, automatically, using processor 112 in electronic communication with electronic bridge platform 104 may arrange for first electronic bridge 110 to serve as an electronic staging area to address non-production task 120 in non-production level environment 116. First electronic bridge 110 may be provided by electronic bridge platform 104.

At step 4, processor 112 may determine information about responders 128 in the organization. The information may include if responders 128 are qualified to address non-production task 120 in non-production level environment 116. The information may include if responders 128 are on-call to address matters arising in non-production level environment 116.

At step 5, transmitter 108 in electronic communication with processor 112 may transmit an API request using API 130 to electronic bridge platform 104. The API request may determine all electronic bridges taking place in production level environment 122. The API request may determine all electronic bridges taking place in non-production level environment 116. API request may determine all responders who are on electronic bridges taking place in production level environment 122.

Electronic bridge platform 104 may be in electronic communication with non-production virtual on-watch 118 in non-production level environment 116 and/or production virtual on-watch 124 in production level environment 122. Non-production virtual on-watch 118 may include a comprehensive review of resources available in non-production level environment 116. Production virtual on-watch 124 may include a comprehensive review of resources available in production level environment 122.

Step 6 may include transmitter 108, in electronic communication with processor 112, receiving an API response with data from electronic bridge platform 104. The data may include information about all electronic bridges taking place in production level environment 122 and in non-production level environment 116. Information may include responders 128 who are on electronic bridges taking place in production level environment 122 and non-production level environment 116. The API response may include electronic bridge platform information from non-production virtual on-watch 118 and production virtual on-watch 124.

Step 7 may include processor 112, using the API response, to determine a set of responders 128 that are qualified to address non-production task 120, are on-call to address matters arising in non-production level environment 116, are not on an electronic bridge in production level environment 122, and are not on an electronic bridge in non-production level environment 116. This determination may be assisted by integrating feedback from production virtual on-watch 124 with non-production virtual on-watch 118.

Step 8 may include using processor 112, in electronic communication with electronic bridge platform 104, to send one or more responders from the set of responders 128 an electronic prompt to join the first electronic bridge. The one or more responders may be identified as being qualified to address non-production task 120, as being on-call to address matters arising in non-production level environment 116, and/or are not currently on an electronic bridge in production level environment 122 or in non-production level environment 116.

Step 9 may the processor 112, in electronic communication with electronic bridge platform 104, receiving an acceptance of the electronic prompt to join the first electronic bridge from the one or more responders from the set of responders 128.

Occasionally, after one or more responders join first electronic bridge 110, at least one of the responders may leave first electronic bridge 110 to join another electronic bridge that is addressing service outage incident 126 in production level environment 122. The system may be configured to replace at least one responder who has left first electronic bridge 110 in a similar manner as the responder was originally identified.

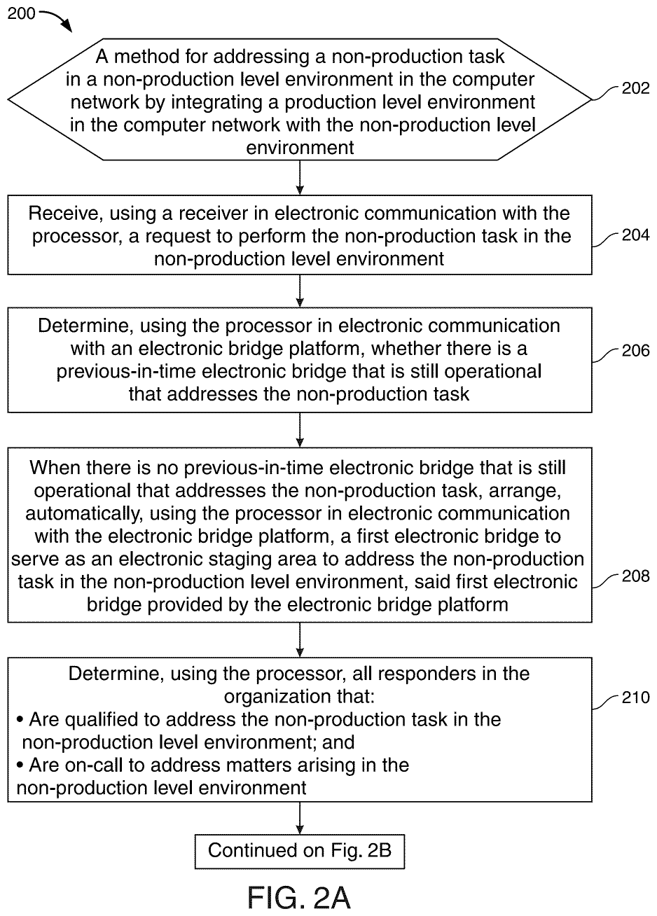

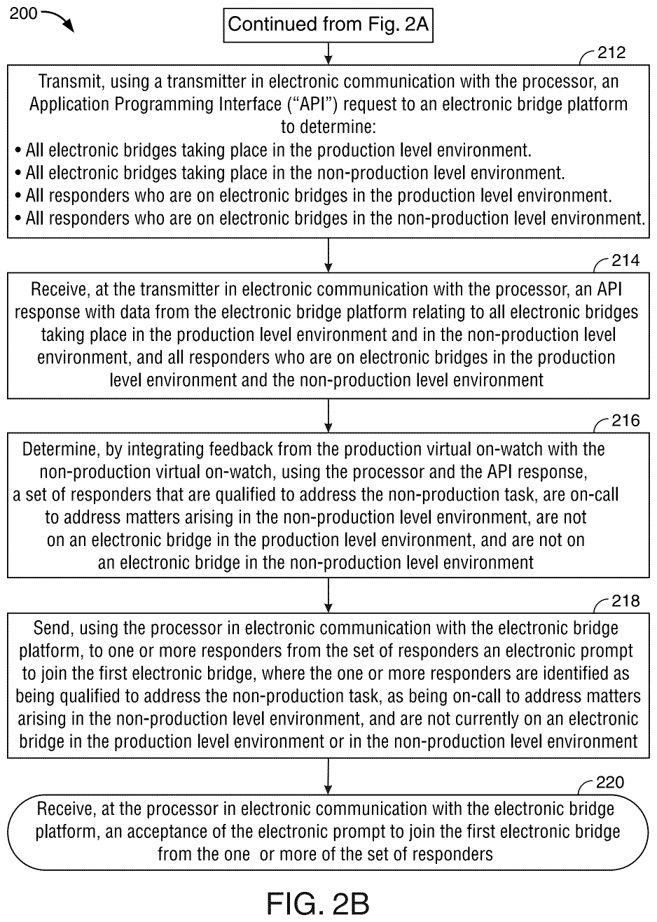

FIG. 2A shows illustrative flowchart 200. Illustrative flowchart 200 may begin at step 202 that describes a method for addressing a non-production task in a non-production level environment in the computer network by integrating a production level environment in the computer network with the non-production level environment.

At step 204, a receiver, in electronic communication with the processor, may receive a request to perform the non-production task in the non-production level environment.

At step 206, the processor, in electronic communication with an electronic bridge platform, may determine whether there is a previous-in-time electronic bridge that is still operational that addresses the non-production task.

At step 208, when there is no previous-in-time electronic bridge that is still operational that addresses the non-production task, the processor, in electronic communication with the electronic bridge platform, may automatically arrange a first electronic bridge to serve as an electronic staging area to address the non-production task in the non-production level environment. The first electronic bridge may be provided by the electronic bridge platform.

At step 210, the processor may determine all responders in the organization that are qualified to address the non-production task in the non-production level environment and/or are on-call to address matters arising in the non-production level environment.

FIG. 2B shows illustrative flowchart 200. Illustrative flowchart 200 may continue from FIG. 2A. Illustrative flowchart 200 may continue at step 212. At step 212, a transmitter in electronic communication with the processor may transmit an API request to an electronic bridge platform. The API request may determine one or more of the following: all electronic bridges taking place in the production level environment, all electronic bridges taking place in the non-production level environment, all responders who are on electronic bridges in the production level environment, and all responders who are on electronic bridges in the non-production level environment.

At step 214, the transmitter in electronic communication with the processor may receive an API response. The API response may contain data from the electronic bridge platform relating to one or more of the following: all electronic bridges taking place in the production level environment and in the non-production level environment, and all responders who are on electronic bridges in the production level environment and the non-production level environment.

At step 216, the processor, using the API response, may integrate feedback from the production virtual on-watch with the non-production virtual on-watch to determine a set of responders. The set of responders may include ones that are qualified to address the non-production task, are on-call to address matters arising in the non-production level environment, are not on an electronic bridge in the production level environment, and/or are not on an electronic bridge in the non-production level environment.

At step 218, the processor, in electronic communication with the electronic bridge platform, may send to one or more responders from the set of responders an electronic prompt to join the first electronic bridge. The one or more responders may be identified as being qualified to address the non-production task, as being on-call to address matters arising in the non-production level environment, and/or are not currently on an electronic bridge in the production level environment or in the non-production level environment.

At step 220, the processor, in electronic communication with the electronic bridge platform, may receive an acceptance of the electronic prompt to join the first electronic bridge from the one or more of the set of responders.

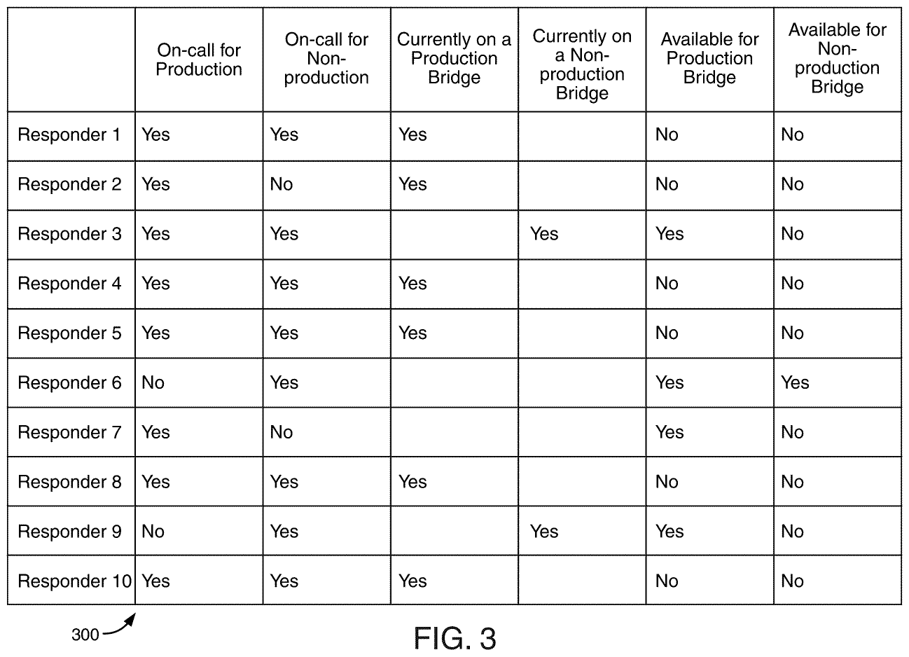

FIG. 3 shows an illustrative table showing the availability of on-call responders. Ten responders are shown in the first column, each responder appearing in a separate row, in the table for the sake of illustration. For each responder, columns describing different statuses may be shown. The second column may describe whether a responder is on-call for production, meaning if a need such as a service outage incident arises, a ‘yes’ in this column may mean that the responder could be called upon to participate in a bridge addressing the incident. The third column may describe whether a responder is on-call for non-production, meaning if a need such as a non-production task arises, a ‘yes’ in this column may mean that the responder could be called upon to participate in a bridge addressing the task.

The fourth column may describe whether the responder is currently on a production bridge. A ‘yes’ in this column may mean that the responder is currently on a bridge involving a matter pertaining to the production level environment. The fifth column may describe whether the responder is currently on a non-production bridge. A ‘yes’ in this column may mean that the responder is currently on a bridge involving a matter pertaining to the non-production level environment.

The sixth column may describe whether the responder is available for a production bridge. This may include a responder that is on-call for production and is not currently on a bridge in the production level environment. However, if the responder is currently on a bridge in the non-production level environment, prioritization rules may provide for the responder to leave the non-production bridge and join the production bridge.

The seventh column may describe whether the responder is available for a non-production bridge. This may include a responder that is on-call for non-production and is not currently on a bridge in the production level environment or the non-production level environment. Needing a responder on a bridge in the non-production level environment, according to prioritization rules, may pull from responders that are not on a production bridge or a non-production bridge.

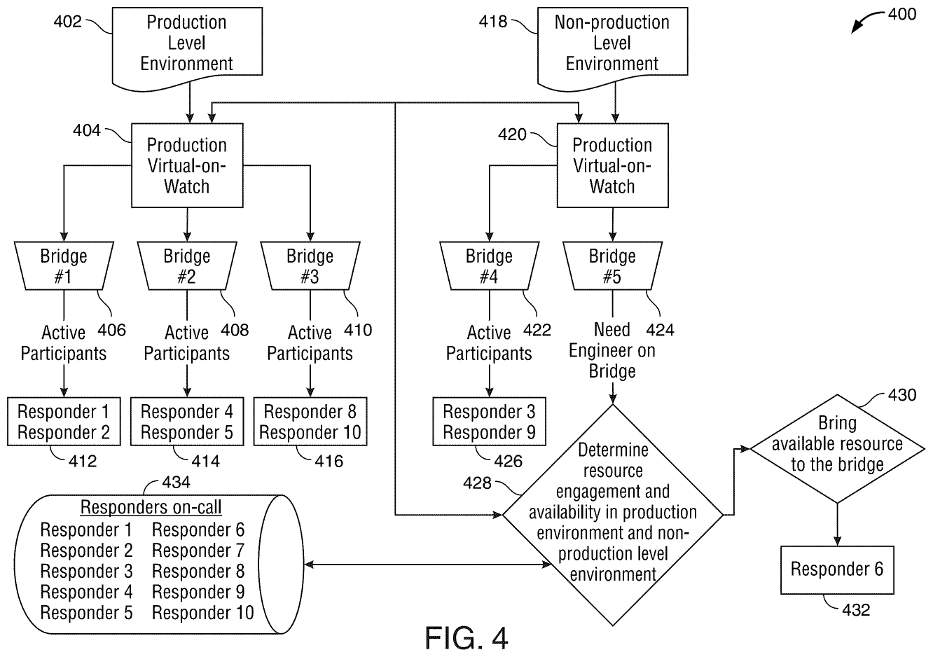

FIG. 4 shows an illustrative block diagram for addressing a non-production task in a non-production level environment in a computer network of an organization by integrating a production level environment in the computer network with the non-production level environment.

Production level environment 402 may include production virtual on-watch 404. Production virtual on-watch may include, at the snapshot shown in this figure, three bridges, bridge #1 406, bridge #2 408, and bridge #3 410. These bridges in the production level environment may address, for example, service outage incidents. Each of the bridges may include active participants. Bridge #1 406 may include, at 412, responder 1 and responder 2. Bridge #2 408 may include, at 414, responder 4 and responder 5. Bridge #3 410 may include, at 416, responder 8 and responder 10.

Non-production level environment 418 may include non-production virtual on-watch 420. Non-production virtual on-watch may include, at the snapshot shown in this figure, two bridges, bridge #4 422 and bridge #5 424. These bridges in the non-production level environment may address, for example, non-production tasks. Non-production task may include a task that addresses a change request (“CRQ”), manages a database, implements a security feature, reviews code, designs software architecture, writes code, tests applications, debugs an engineering issue, optimizes performance of a component located in the production level environment or non-production level environment, documents technical specifications, collaborates with teams in the production level environment, or maintains existing software systems to address updates or fix bugs.

Bridge #4 422 may include active participants, as shown in 426, responder 3 and responder 9. Bridge #5 424 may need an engineer on the bridge. An engineer may include a responder. The block diagram may continue at 428 to determine resource engagement and availability in the production level environment and the non-production level environment. An API request may go out to production virtual on-watch 404 and non-production virtual on-watch 420 to see which responders are currently on bridges. The API request may also go out to a processor that possesses a current list of responders on-call 434. With this information, one or more responders may be identified that are qualified to address the non-production task, are on-call to address matters arising in the non-production level environment, are not on an electronic bridge in the production level environment, and are not on an electronic bridge in the non-production level environment.

An electronic prompt may be provided to the one or more responders at 430, bringing available resources to the bridge, to responders that are qualified to address the non-production task. At 432, responder 6 may accept the invitation to join bridge #5 424.

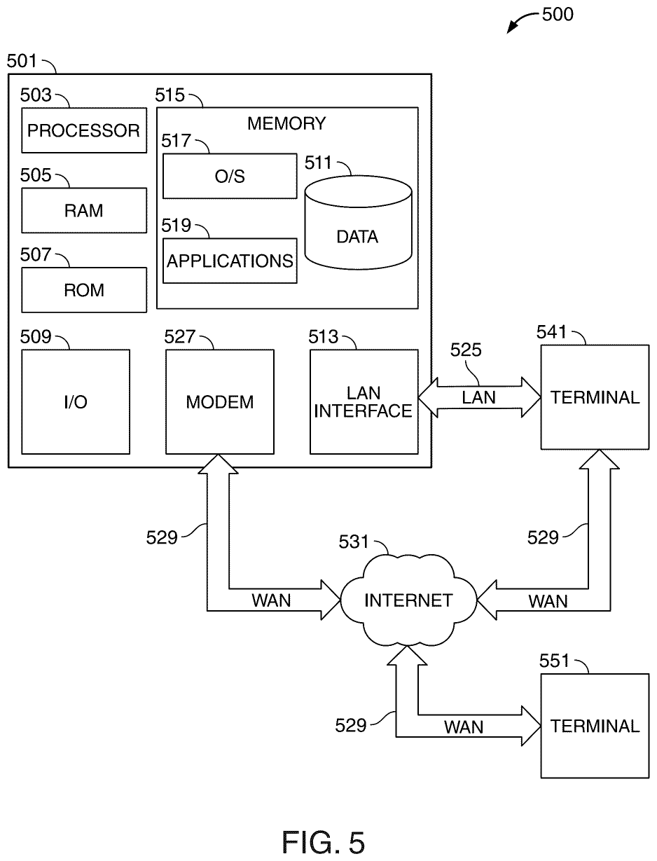

FIG. 5 shows an illustrative block diagram of system 500 that includes computer 501. Computer 501 may alternatively be referred to herein as an “engine,” “server” or a “computing device.” Computer 501 may be a workstation, desktop, laptop, tablet, smartphone, or any other suitable computing device. Elements of system 500, including computer 501, may be used to implement various aspects of the systems and methods disclosed herein, including those shown in FIGS. 1, 2A and 2B. Each of the systems, methods, and algorithms illustrated in FIGS. 1, 2A and 2B may include some or all the elements of system 500.

Computer 501 may have a processor 503, including a central processing unit (“CPU”), for controlling the operation of the device and its associated components, and may include RAM 505, ROM 507, input/output (“I/O”) 509, and a non-transitory or non-volatile memory 515. Machine-readable memory may be configured to store information in machine-readable data structures. Processor 503 may also execute all software running on the computer. Other components, such as graphics processing unit (“GPU”), EEPROM, Flash memory, neural-network processing elements, or any other suitable components, may also be part of the computer 501.

Memory 515 may be comprised of any suitable permanent storage technology, such as a hard drive. Memory 515 may store software including the operating system 517 and application program(s) 519 along with any data 511 needed for the operation of system 500. Memory 515 may also store videos, text, and/or audio assistance files. The data stored in memory 515 may also be stored in cache memory, or any other suitable memory.

I/O module 509 may include connectivity to a microphone, keyboard, touch screen, mouse, and/or stylus through which input may be provided into computer 501. The input may include input relating to cursor movement. The input/output module may also include one or more speakers for providing audio output and a video display device for providing textual, audio, audiovisual, and/or graphical output. The input and output may be related to computer application functionality.

System 500 may be connected to other systems via a local area network interface 513. System 500 may operate in a networked environment supporting connections to one or more remote computers, such as terminals 541 and 551. Terminals 541 and 551 may be personal computers or servers that include many, or all the elements described above relative to system 500. The network connections depicted in FIG. 5 include a local area network (“LAN”) 525 and a wide area network (“WAN”) 529 but may also include other networks. When used in a LAN networking environment, computer 501 is connected to LAN 525 through LAN interface 513 or an adapter. When used in a WAN networking environment, computer 501 may include a modem 527 or other means for establishing communications over WAN 529, such as Internet 531.

It will be appreciated that the network connections shown are illustrative and other means of establishing a communications link between computers may be used. The existence of various well-known protocols such as TCP/IP, Ethernet, FTP, HTTP, and the like is presumed, and the system can be operated in a client-server configuration to permit retrieval of data from a web-based server or an API. Web-based, for the purposes of this application, is to be understood to include a cloud-based system. The web-based server may transmit data to any other suitable computer system. The web-based server may also send computer-readable instructions, together with the data, to any suitable computer system. The computer-readable instructions may include instructions to store the data in cache memory, the hard drive, secondary memory, or any other suitable memory.

Additionally, application program(s) 519, which may be used by computer 501, may include computer executable instructions for invoking functionality related to communication, such as e-mail, Short Message Service (“SMS”), and voice input and speech recognition applications. Application program(s) 519 (which may be alternatively referred to herein as “plugins,” “applications,” or “apps”) may include computer executable instructions for invoking functionality related to performing various tasks. Application program(s) 519 may utilize one or more algorithms that process receive executable instructions, perform power management routines or other suitable tasks.

Application program(s) 519 may include computer executable instructions (alternatively referred to as “programs”). The computer executable instructions may be embodied in hardware or firmware (not shown). Computer 501 may execute the instructions embodied by the application program(s) 519 to perform various functions.

Application program(s) 519 may utilize the computer-executable instructions executed by a processor. Programs may include routines, programs, objects, components, data structures, etc., that perform tasks or implement abstract data types. A computing system may be operational with distributed computing environments. Tasks may be performed by remote processing devices that are linked through a communications network. In a distributed computing environment, a program may be in both local and remote computer storage media including memory storage devices. Computing systems may rely on a network of remote servers hosted on the Internet to store, manage, and process data (e.g., “cloud computing” and/or “fog computing”).

Any information described above in connection with data 511, and any other suitable information, may be stored in memory 515.

The disclosure may be described in the context of computer-executable instructions, such as application(s) 519, being executed by a computer. Programs may include routines, programs, objects, components, data structures, etc., that perform tasks or implement data types. The computer-executable instructions may be located on one or more non-transitory computer-readable media. The computer-executable instructions, when executed by processor 503, may be used to implement various aspects of the systems and methods disclosed herein.

The disclosure may also be practiced in distributed computing environments. Tasks may be performed by remote processing devices that are linked through a communications network. A communications network may include a computer network. In a distributed computing environment, programs may be in both local and remote computer storage media including memory storage devices. It should be noted that such programs may be considered for the purposes of this application as engines with respect to the performance of the tasks to which the programs are assigned.

Computer 501 and/or terminals 541 and 551 may also include various other components, such as a battery, speaker, and/or antennas (not shown). Components of computer system 501 may be linked by a system bus, wirelessly or by other suitable interconnections. Components of computer system 501 may be present on one or more circuit boards. In some embodiments, the components may be integrated into a single chip. The chip may be silicon-based.

Terminal 541 and/or terminal 551 may be portable devices such as a laptop, cell phone, tablet, smartphone, or any other computing system for receiving, storing, transmitting, and/or displaying relevant information. Terminal 541 and/or terminal 551 may be one or more user devices. Terminals 541 and 551 may be identical to system 500 or different. Differences may be related to hardware components and/or software components.

The disclosure may be operational with numerous other general purpose or special purpose computing system environments or configurations. Examples of well-known computing systems, environments, and/or configurations that may be suitable for use with the disclosure include, but are not limited to, personal computers, server computers, hand-held or laptop devices, tablets, mobile phones, smart phones and/or other personal digital assistants (“PDAs”), multiprocessor systems, microprocessor-based systems, cloud-based systems, programmable consumer electronics, network PCs, minicomputers, mainframe computers, distributed computing environments that include any of the above systems or devices, and the like.

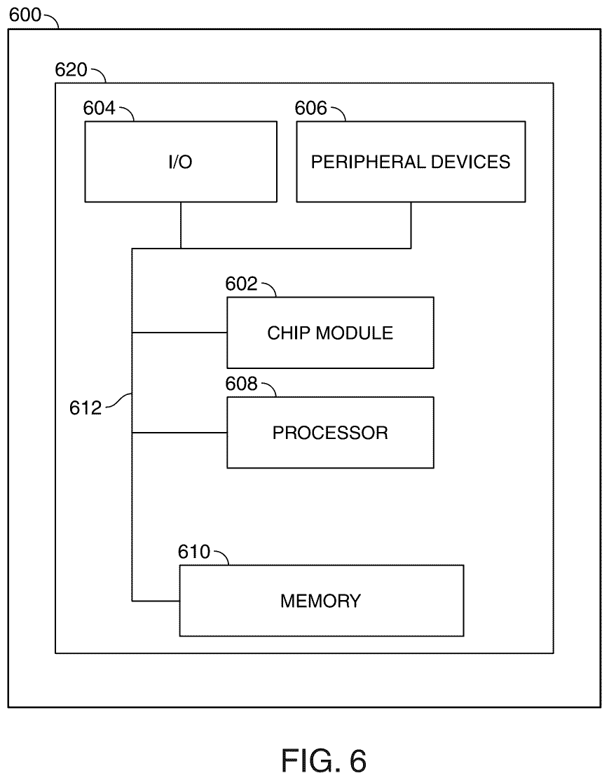

FIG. 6 shows an illustrative system 600 that may be configured in accordance with the principles of the disclosure. System 600 may be a computing device. System 600 may include one or more features of the apparatus shown in FIG. 5. System 600 may include chip module 602, that may include one or more integrated circuits, and that may include logic configured to perform any other suitable logical operations.

System 600 may include one or more of the following components: I/O circuitry 604, that may include a transmitter device and a receiver device and may interface with fiber optic cable, coaxial cable, telephone lines, wireless devices, PHY layer hardware, a keypad/display control device or any other suitable media or devices; peripheral devices 606, that may include counter timers, real-time timers, power-on reset generators or any other suitable peripheral devices; logical processing device 608, that may compute data structural information and structural parameters of the data; and machine-readable memory 610.

Machine-readable memory 610 may be configured to store in machine-readable data structures: machine executable instructions, (which may be alternatively referred to herein as “computer instructions” or “computer code”), applications such as applications 519 (shown in FIG. 5), signals, and/or any other suitable information or data structures.

A system bus or other interconnections 612 may couple components 602, 604, 606, 608 and 610 and may be present on one or more circuit boards such as circuit board 620. In some embodiments, a single chip may integrate the components. The chip may be silicon-based.

Elements of system 600, including circuit board 620 and various coupled components found on circuit board 630, may be used to implement various aspects of the systems and methods disclosed herein, including those shown in FIGS. 1, 2A, 2B, 3, 4, and 5. Each of the systems and methods illustrated in FIGS. 1, 2A, 2B, 3, 4, and 5 may include some or all the elements of system 600.

Thus, provided may be systems and methods relating to integrating the production level environment and the non-production level environment in a computer network to address the non-production task, for example, by organization a set of responders that are qualified and available to participate on an electronic bridge to respond to the non-production task. People skilled in the art will appreciate that the present invention can be practiced by other than the described embodiments, which are presented for purposes of illustration rather than of limitation. The present invention is limited only by the claims that follow.

What is claimed is:

1. A system for addressing a non-production task in a non-production level environment in a computer network of an organization by integrating a production level environment in the computer network with the non-production level environment, the system comprising:
a processor located in the computer network of the organization;
a receiver in the computer network, said receiver in electronic communication with the processor;
a transmitter in the computer network, said transmitter in electronic communication with the processor;
a non-production level environment in the computer network;
a non-production virtual on-watch in the non-production level environment, said non-production virtual on-watch comprises a comprehensive review of resources available in the non-production level environment;
a production level environment in the computer network;
a production virtual on-watch in the production level environment, said production virtual on-watch comprises a comprehensive review of resources available in the production level environment;
a first electronic bridge;
said receiver is configured to:
receive a request to perform the non-production task in the non-production level environment;
said processor in electronic communication with an electronic bridge platform is configured to:
determine whether there is a previous-in-time electronic bridge that is still operational that addresses the non-production task;
when there is no previous-in-time electronic bridge that is still operational that addresses the non-production task, arrange, automatically, the first electronic bridge to serve as an electronic staging area to address the non-production task in the non-production level environment, said first electronic bridge provided by the electronic bridge platform;
said transmitter is configured to:
transmit an Application Programming Interface (“API”) request to an electronic bridge platform to determine:
all electronic bridges taking place in the production level environment;
all electronic bridges taking place in the non-production level environment;
all responders who are on electronic bridges taking place in the production level environment; and
all responders who are on electronic bridges taking place in the non-production level environment;
wherein the electronic bridge platform is in electronic communication with the non-production virtual on-watch and the production virtual on-watch;
receive an API response with data from the electronic bridge platform relating to all electronic bridges taking place in the production level environment and in the non-production level environment, and all responders who are on electronic bridges taking place in the production level environment and the non-production level environment;
wherein the API response comprises electronic bridge platform information from the non-production virtual on-watch and the production virtual on-watch;
said processor is configured to:
determine all responders in the organization that:
are qualified to address the non-production task in the non-production level environment; and
are on-call to address matters arising in the non-production level environment;
determine, by integrating feedback from the production virtual on-watch with the non-production virtual on-watch, and with use of the API response, a set of responders that are qualified to address the non-production task, are on-call to address matters arising in the non-production level environment, are not on an electronic bridge in the production level environment, and are not on an electronic bridge in the non-production level environment;
said processor in electronic communication with an electronic bridge platform is configured to:
send to one or more responders from the set of responders an electronic prompt to join the first electronic bridge, where the one or more responders are identified as being qualified to address the non-production task, as being on-call to address matters arising in the non-production level environment, and are not currently on an electronic bridge in the production level environment or in the non-production level environment; and
receive an acceptance of the electronic prompt to join the first electronic bridge from the one or more of the set of responders.

2. The system of claim 1 wherein the non-production task comprises a task that addresses a change request (“CRQ”), manages a database, implements a security feature, reviews code, designs software architecture, writes code, tests applications, debugs an engineering issue, optimizes performance of a component located in the production level environment or non-production level environment, documents technical specifications, collaborates with teams in the production level environment, or maintains existing software systems to address updates or fix bugs.

3. The system of claim 1 wherein the non-production task does not comprise a service outage incident.

4. The system of claim 1 wherein:
the computer network comprises a computer network of an organization, and the set of responders are associated with the organization; and
the production virtual on-watch and the non-production virtual on-watch comprise different virtual on-watches.

5. The system of claim 1 wherein:
the computer network comprises a computer network of an organization, and the set of responders are associated with the organization; and
the production virtual on-watch comprises the non-production virtual on-watch.

6. The system of claim 1 wherein the non-production task is not addressed at the production level environment.

7. The system of claim 1 wherein said non-production level environment of the computer network comprises a lower level environment and an upper level environment.

8. The system of claim 1 wherein when the one or more responders join the first electronic bridge, the one or more responders leave the first electronic bridge when the first electronic bridge is terminated or when participation of the one or more responders in the first electronic bridge is completed.

9. The system of claim 1 wherein, when the one or more responders joins the first electronic bridge, at least one responder of the one or more responders leaves the first electronic bridge to join another electronic bridge that is addressing a service outage incident in the production level environment, the system is further configured to replace the at least one responder who has left the first electronic bridge.

10. One or more non-transitory computer-readable media storing computer-executable instructions which, when executed by a processor located in a computer network of an organization, perform a method for addressing a non-production task in a non-production level environment in the computer network by integrating a production level environment in the computer network with the non-production level environment, the method comprising:
receiving, using a receiver in electronic communication with the processor, a request to perform the non-production task in the non-production level environment;
determining, using the processor in electronic communication with an electronic bridge platform, whether there is a previous-in-time electronic bridge that is still operational that addresses the non-production task;
when there is no previous-in-time electronic bridge that is still operational that addresses the non-production task, arranging, automatically, using the processor in electronic communication with the electronic bridge platform, a first electronic bridge to serve as an electronic staging area to address the non-production task in the non-production level environment, said first electronic bridge provided by the electronic bridge platform;
determining, using the processor, all responders in the organization that:
are qualified to address the non-production task in the non-production level environment; and
are on-call to address matters arising in the non-production level environment;
transmitting, using a transmitter in electronic communication with the processor, an Application Programming Interface (“API”) request to an electronic bridge platform to determine:
all electronic bridges taking place in the production level environment;
all electronic bridges taking place in the non-production level environment;
all responders who are on electronic bridges taking place in the production level environment; and
all responders who are on electronic bridges taking place in the non-production level environment;
wherein the electronic bridge platform is in electronic communication with a non-production virtual on-watch in the non-production level environment and a production virtual on-watch in the production level environment, said non-production virtual on-watch comprises a comprehensive review of resources available in the non-production level environment, and said production virtual on-watch comprises a comprehensive review of resources available in the production level environment;
receiving, at the transmitter in electronic communication with the processor, an API response with data from the electronic bridge platform relating to all electronic bridges taking place in the production level environment and in the non-production level environment, and all responders who are on electronic bridges taking place in the production level environment and the non-production level environment;
wherein the API response comprises electronic bridge platform information from the non-production virtual on-watch and the production virtual on-watch;
determining, by integrating feedback from the production virtual on-watch with the non-production virtual on-watch, using the processor and the API response, a set of responders that are qualified to address the non-production task, are on-call to address matters arising in the non-production level environment, are not on an electronic bridge in the production level environment, and are not on an electronic bridge in the non-production level environment;
sending, using the processor in electronic communication with the electronic bridge platform, to one or more responders from the set of responders an electronic prompt to join the first electronic bridge, where the one or more responders are identified as being qualified to address the non-production task, as being on-call to address matters arising in the non-production level environment, and are not currently on an electronic bridge in the production level environment or in the non-production level environment; and
receiving, at the processor in electronic communication with the electronic bridge platform, an acceptance of the electronic prompt to join the first electronic bridge from the one or more responders of the set of responders.

11. The method of claim 10 wherein the non-production task comprises a task that addresses a change request (“CRQ”), manages a database, implements a security feature, reviews code, designs software architecture, writes code, tests applications, debugs an engineering issue, optimizes performance of a component located in the production level environment or non-production level environment, documents technical specifications, collaborates with teams in the production level environment, or maintains existing software systems to address updates or fix bugs.

12. The method of claim 10 wherein the non-production task does not comprise a service outage incident in the production level environment.

13. The method of claim 10 wherein:
the computer network comprises a computer network of an organization, and the set of responders are associated with the organization; and
the production virtual on-watch and the non-production virtual on-watch comprise different virtual on-watches.

14. The method of claim 10 wherein:
the computer network comprises a computer network of an organization, and the set of responders are associated with the organization; and
the production virtual on-watch comprises the non-production virtual on-watch.

15. The method of claim 10 wherein the non-production task is not addressed at the production level environment.

16. The method of claim 10 wherein said non-production level environment of the computer network comprises a lower level environment and an upper level environment.

17. The method of claim 10 wherein after the one or more responders join the first electronic bridge, the one or more responders leave the first electronic bridge when the first electronic bridge is terminated or when participation of the one or more responders in the first electronic bridge is completed.

18. The method of claim 10 further comprising:
receiving, at the processor, notification that at least one responder of the one or more responders has left the first electronic bridge to join another electronic bridge that is addressing a service outage incident in the production level environment,
sending, using the processor in electronic communication with the electronic bridge platform, an electronic prompt to join the first electronic bridge to one or more responders of a second set of responders, where the one or more responders of the second set or responders are identified as being qualified to address the non-production task, as being on-call to address matters arising in the non-production level environment, and are not currently on an electronic bridge in the production level environment or in the non-production level environment; and
receiving, at the processor in electronic communication with the electronic bridge platform, an acceptance of the electronic prompt to join the first electronic bridge from the one or more responders of the second set of responders.

19. A system for addressing a non-production task in a non-production level environment in a computer network of an organization by integrating a production level environment in the computer network with the non-production level environment, the system comprising:
a processor located in the computer network of the organization;
a receiver in the computer network, said receiver in electronic communication with the processor;
a transmitter in the computer network, said transmitter in electronic communication with the processor;
a non-production level environment in the computer network;
a non-production virtual on-watch in the non-production level environment, said non-production virtual on-watch comprises a comprehensive review of resources available in the non-production level environment;
a production level environment in the computer network;
a production virtual on-watch in the production level environment, said production virtual on-watch comprises a comprehensive review of resources available in the production level environment, and said production virtual on-watch and non-production virtual on-watch comprise different virtual on-watches;
a first electronic bridge;
said receiver is configured to:
receive a request to perform the non-production task in the non-production level environment;
wherein:
said non-production task comprises a task that addresses a change request (“CRQ”), manages a database, implements a security feature, reviews code, designs software architecture, writes code, tests applications, debugs an engineering issue, optimizes performance of a component located in the level production environment or non-production level environment, documents technical specifications, collaborates with teams in the production level environment, or maintains existing software systems to address updates or fix bugs; and
does not comprise a service outage incident;
said processor in electronic communication with an electronic bridge platform is configured to:
determine whether there is a previous-in-time electronic bridge that is still operational that addresses the non-production task;
when there is no previous-in-time electronic bridge that is still operational that addresses the non-production task, arrange, automatically, the first electronic bridge to serve as an electronic staging area to address the non-production task in the non-production level environment, said first electronic bridge provided by the electronic bridge platform;
said transmitter is configured to:
transmit an Application Programming Interface (“API”) request to an electronic bridge platform to determine:
all electronic bridges taking place in the production level environment;
all electronic bridges taking place in the non-production level environment;
all responders who are on electronic bridges taking place in the production level environment; and
all responders who are on electronic bridges taking place in the non-production level environment;
wherein the electronic bridge platform is in electronic communication with the non-production virtual on-watch and the production virtual on-watch;
receive an API response with data from the electronic bridge platform relating to all electronic bridges taking place in the production level environment and in the non-production level environment, and all responders who are on electronic bridges taking place in the production level environment and the non-production level environment;
wherein the API response comprises electronic bridge platform information from the non-production virtual on-watch and the production virtual on-watch;
said processor is configured to:
determine all responders in the organization that:
are qualified to address the non-production task in the non-production level environment; and
are on-call to address matters arising in the non-production level environment;
determine, by integrating feedback from the production virtual on-watch with the non-production virtual on-watch, and with use of the API response, a set of responders that are qualified to address the non-production task, are on-call to address matters arising in the non-production level environment, are not on an electronic bridge in the production level environment, and are not on an electronic bridge in the non-production level environment;
said processor in electronic communication with an electronic bridge platform is configured to:
send to one or more responders from the set of responders an electronic prompt to join the first electronic bridge, where the one or more responders are identified as being qualified to address the non-production task, as being on-call to address matters arising in the non-production level environment, and are not currently on an electronic bridge in the production level environment or in the non-production level environment; and
receive an acceptance of the electronic prompt to join the first electronic bridge from the one or more of the set of responders.

20. The system of claim 19 wherein when the one or more responders join the first electronic bridge, the one or more responders leave the first electronic bridge when the first electronic bridge is terminated or when participation of the one or more responders in the first electronic bridge is completed.
